(19) United States
(12) Patent Application Publication
(10) Pub. No.: US 2011/0169263 A1
(43) Pub. Date: Jul. 14, 2011

(54) HEAT EXCHANGER, HEAT EXCHANGER ADHESIVE CONNECTION, AND HEAT EXCHANGER PRODUCTION METHOD

(76) Inventors: Denis Bazika, Esslingen (DE); Rainer Käsinger, Haiterbach (DE); Fritz Keller, Tubingen (DE); Wolfgang Schatz-Knecht, Stuttgart (DE); Jens Köppen, Stuttgart (DE); Jens Nies, Holzgerlingen (DE); Jochen Orso, Reutlingen (DE); Andreas Stolz, Walddorfhaslach (DE); Werner Zobel, Boblingen (DE)

(21) Appl. No.: 12/987,805

(22) Filed: Jan. 10, 2011

Related U.S. Application Data
(63) Continuation of application No. PCT/EP2008/010422, filed on Dec. 9, 2008.

(30) Foreign Application Priority Data
Jul. 9, 2008 (DE) 10 2008 032 287.3
Oct. 22, 2008 (DE) 10 2008 052 723.8

(51) Int. Cl. F16L 47/00; C09J 183/04; B32B 38/16; B32B 37/12

(52) U.S. Cl. 285/293.1; 156/329; 156/281

(57) ABSTRACT

A heat exchanger and a method of manufacturing a heat exchanger are described and shown. In some embodiments, the heat exchanger has a brazed core with flat metal tubes and flat metal tube ends received in corresponding openings defined in a collecting tank, and has a plurality of adhesive connections each with an annular space around a flat tube end and defined at least in part by the collecting tank, an addition-crosslinking silicone adhesive located within the annular space, and a mounting plate at least partially closing each annular space. In some embodiments, a method for producing an adhesive connection for flat metal tube ends in corresponding openings of a collecting tank of a heat exchanger is provided, and includes pushing an addition-crosslinking type silicone adhesive into annular spaces located between each flat tube end and a corresponding opening of the collecting tank with a mounting plate, at least partially filling the annular spaces by pushing the silicone adhesive into the annular spaces with the mounting plate, and closing the annular spaces with the mounting plate.

### CROSS-REFERENCE TO RELATED APPLICATIONS

This is a continuation application of PCT Patent App. No. PCT/EP2008/010422 filed on Dec. 9, 2008, which claims priority to German Patent App. No. 10 2008 032 287.3 filed on Jul. 9, 2008 and German Patent App. No. 10 2008 052 723.8 filed on Oct. 22, 2008, the entire contents of all of which are incorporated herein by reference.

### BACKGROUND

The invention relates, among other things, to an adhesive connection for heat exchangers, in particular an adhesive connection of flat metal tube ends that are part of a brazed heat exchanger network, in corresponding openings in a collecting tank made of plastic, each opening having an annular space around the tube ends, with a silicone adhesive in the annular spaces. The invention also relates, among other things, to a production method for adhesive assembly of a heat exchanger and for the heat exchanger itself.

An adhesive connection and production method are known from previously unpublished German patent application number DE 10 2008 021 544.9.

In WO 2006/010435A1, a silicone-based adhesive is likewise used to produce a heat exchanger for motor vehicles. The adhesive disclosed therein is an initially liquid composition which is poured on the inner side of a tube sheet and then cured. There is no annular space around the tube ends at this location. Also, the tube ends are deformed (i.e., widened), which involves a certain expenditure in terms of production. A large amount of adhesive is also required in the disclosed method, likewise increasing production costs.

WO 2007/009588A1 discloses an automobile radiator which likewise has deformed tube ends, and does not have annular spaces as discussed above. The tube ends in the '588 application have not been adhesively fixed in place, but are instead fastened by bending the tube ends. This automobile radiator also has a separate metal tube sheet, which is regarded as disadvantageous.

DE 38 09 944 C2 discloses a radiator for internal combustion engines in motor vehicles, and also discloses the use of annular spaces. Adhesive is introduced into the annular spaces by means of a metering device and by way of channels leading to the annular spaces. The annular spaces are completely filled with the adhesive. The adhesive is relatively expensive. Moreover, considerable adhesive is required in the disclosed method. The '944 document also proposes to use adhesives that are marketed under the trade name “Loctite”. Although this relatively old proposal still appears progressive even today, such radiators have not yet appeared on the market. One of the reasons for this is likely that there has not been success so far in making the adhesive connection durable using the teachings of the '944 document.

Radiators for motor vehicles should be expected to last at least about 10 years while at the same time being able to withstand all conceivable operating situations.

### SUMMARY OF THE INVENTION

A wide range of suitable adhesives have been tested in extensive preliminary trials. Based upon these tests, the inventors have come to the conclusion that silicone adhesives promise the greatest success. Silicone adhesives are either of the so-called condensation-crosslinking type (A) or the addition-crosslinking type (B). The silicone adhesives of the condensation-crosslinking type (A) emit certain substances while curing (e.g., acids or alcohols), while those of the addition-crosslinking type (B) lead to the formation of molecular chains while curing, without emitting substances. The adhesives of type B may have a catalyst, such as platinum or palladium by way of example only. In some cases, such catalysts are usually contained in one of two components which have to be mixed to prepare the adhesive for use. In some embodiments, the catalysts have the effect of shortening curing time, but they may also help to reduce the temperature required for curing.

An object of some embodiments of the present invention is to propose or provide a long-lasting and durable adhesive connection for heat exchangers, and a production method therefor.

It has been found that the durability of heat exchanger adhesive connections is improved by using silicone adhesives of the addition-crosslinking type, while using a mounting plate which delimits the annular spaces about the tube holes described above. The elastic modulus or the storage modulus of the silicone adhesive is relatively low in order to keep down the forces of changes in tube length induced by temperature changes during heat exchanger operation, and to limit vibrations in the adhesive connection. In some embodiments, the elastic modulus lies between approximately 0.1 and 3.0 MPa.

Some embodiments of the present invention utilize a heat exchanger mounting plate adhesively fastened with its upper side to the collecting tank. The mounting plate may lie with its underside on the fins of the heat exchanger core.

Further functional improvements can be obtained by filling the annular spaces to approximately 60 to 95% with the silicone adhesive. In these and other embodiments, the height of the annular spaces filled with the silicone adhesive can be approximately 5 to 15 mm, and/or the width of the annular spaces can be approximately 0.5 to 3.0 mm.

In those embodiments in which the annular spaces are filled with adhesive to approximately 60 to 95% of their volume, and in which the specified preferred dimensions of the annular spaces are utilized as described above, the elasticity of the adhesive connection is significantly increased, as confirmed on the basis of numerous series of tests. To date, all radiators tested in the laboratory and placed into internal practical use have met expectations.

With respect to dimensioning of the annular spaces described above, it has been found that proper dimensioning depends at least in part upon the intended length of the flat tubes in each individual case, and upon the dimensions of the cross sections of the flat tubes. For example, for flat tubes of charge air coolers, which may be approximately 10 mm thick (see dimension d in FIG. 5), the width and height of the annular spaces will typically be chosen at the upper limits. For flat tubes of cooling liquid coolers, which may be only approximately 1.0 to 1.5 mm thick (again, see dimension d in FIG. 5), width dimensions of the annular spaces at the lower limit tend to be suitable. In the case of somewhat longer flat tubes (e.g., up to or over 1.0 m) as encountered in the case of trucks, a somewhat wider and higher filled annular space would likewise tend to be provided, because the changes in length of the flat tubes that are to be expected as a result of temperature changes can be compensated better by means of the elasticity of the adhesive connections. For example, under such exposure to changing temperatures, an originally approximately rectangular cross-sectional area of adhesive in the annular space will shift to have a parallelogram-shaped cross-sectional area—and then back again to a rectangular shape. This shifting is ensured by the elastic properties of the selected adhesive, together with the proposed manner in which it is formed.

In the case of previously brazed coolers, failures are often caused by ruptures in the brazed connections between tubes and tube sheets, because there is not the required elasticity. It is expected that the present invention will lead to improvements in this respect. In some embodiments, a silicone adhesive consisting of two components will be used. However, the adhesive may also be a silicone adhesive with a single component.

The tensile strength of the silicone adhesive that is used can lie at approximately 3.0 and 7.0 MPa, and in some embodiments lies at approximately 4.0 to 6.0 MPa.

In some embodiments, the elongation of the silicone adhesive that is used is greater than 100%, such as (for example) 150%.

Also, in some embodiments it is of advantage if the silicone adhesive that is used has a catalyst from the group of platinum metals or their compounds.

The dynamic viscosity of some non-cured silicone adhesives used in the present invention is approximately 20,000 to 60,000 cP. With these values, the adhesive can (for example) be applied to the mounting plate in the form of strands without flowing away.

In some embodiments, the annular spaces may have approximately the same width over the height that is filled with the silicone adhesive. However, it is also possible to make the annular spaces slightly conical, with a decreasing and/or increasing width dimension over the height that is filled with the silicone adhesive. In the case of conical or other annular spaces, the width dimensions described herein relate to the mean of the width dimensions over the height of the spaces filled with the silicone adhesive. In this regard, the specified width dimensions can be exceeded slightly in the case of conical annular spaces.

In some embodiments, the part of the annular spaces that is not filled with the silicone adhesive is arranged facing the collecting tank.

Some methods according to the present invention call for producing an adhesive connection for flat metal tube ends in corresponding openings in collecting tanks of a heat exchanger, wherein a silicone adhesive is introduced into a respective annular space between the flat tube ends and the openings, and wherein by means of a mounting plate, the annular spaces are filled with a silicone adhesive of the addition-crosslinking type having a low storage modulus, and are closed.

In some embodiments, the mounting plate has openings corresponding to the flat tubes in order to allow the mounting plate to be fitted onto the flat tube ends so that the underside of the mounting plate lies, for example, on fins on the cooling air side of the heat exchanger. The edges of the openings in the mounting plate can lie closely against the flat tube ends in order to avoid escape of the adhesive as much as possible. In some embodiments, the silicone adhesive is applied to the upper side of the mounting plate, and is forced into the annular spaces when the mounting plate and the collecting tank are subsequently brought together with the flat tube ends being pushed into the openings in the collecting tank.

The flat tube ends are pre-treated in some embodiments, such as being cleaned with a suitable agent in order (for example) to remove fluxes which have proven to be harmful to an adhesive connection of appropriate quality.

The flat tube ends are part of a heat exchanger core of flat tubes and fins on the cooling air side, both of which can be made of aluminium or of aluminium alloys, and can be connected by means of a CAB (controlled atmosphere brazing) method. For this brazing method, normally a noncorrosive flux is typically used. Surface treatments may be required and carried out both on the flat tube ends and on the walls of the tube openings.

In some embodiments, the mounting plate has openings corresponding to the flat tubes to allow the mounting plate to be fitted onto the flat tube ends so that the underside of the mounting plate lies (for example) on fins of the cooling air side of the heat exchanger. According to a further development, the edges of the openings in the mounting plate can lie closely against the flat tube ends in a yielding (i.e., elastic or compliant) manner in order to allow compensation for differences between the distances between the openings in the mounting plate and the distances between the flat tube ends. Alternatively or in addition, the distances between the openings can be varied or adapted by forming the mounting plate in an yielding (i.e., elastic or compliant) manner. This can also ensure that neither the flat tube ends nor the mounting plate are damaged, and that there is no loss of adhesive through excessive gaps between the flat tube ends and the edges of the openings in the mounting plate.

### BRIEF DESCRIPTION OF THE DRAWINGS

Further features of the present invention and their effects are evident from the following description of exemplary embodiments of the present invention and from the accompanying drawings, in which:

FIG. 1 shows preferred dimensions of annular spaces in some embodiments of the present invention, generated as a result of tests conducted;

FIG. 2 shows a perspective partial view of a mounting plate according to an embodiment of the present invention;

FIG. 3 shows a perspective overall view of a mounting plate according to an embodiment of the present invention;

FIG. 4 shows a partial longitudinal section through a collecting tank of a heat exchanger according to an embodiment of the present invention;

FIG. 5 shows a view of a flat tube end used in conjunction with some embodiments of the present invention;

FIG. 6 shows a view of part of a mounting plate with silicone adhesive therein, according to an embodiment of the present invention;

FIG. 7 shows a cross section through a collecting tank according to an embodiment of the present invention;

FIG. 8 shows a perspective partial view of a mounting plate according to an embodiment of the present invention;

FIG. 9 shows a perspective and enlarged partial view of the mounting plate shown in FIG. 8;

FIG. 10 shows a perspective and enlarged partial view of the mounting plate shown in FIGS. 8 and 9, and illustrating an embodiment of how edges of the openings in the mounting plate can be formed in a yielding manner;

FIG. 11 shows a partial cross section of another embodiment of a mounting plate according to the present invention;

FIG. 12 shows a partial cross section of another embodiment of a mounting plate according to the present invention;

FIG. 13 shows a partial cross section of another embodiment of a mounting plate according to the present invention;

FIG. 14 shows a perspective partial view of a mounting plate adapted for making the distances between openings able to yield, according to an embodiment of the present invention;

FIG. 15 shows a perspective partial view of another mounting plate adapted for making the distances between openings able to yield, according to an embodiment of the present invention; and

FIGS. 16 to 18 show a production sequence and frontal view of a heat exchanger according to an embodiment of the present invention.

### DETAILED DESCRIPTION

With reference first to FIGS. 1 and 4, numerous practical tests and simulation calculations in connection with the present invention have shown that the preferred width b of an annular space 6 about each flat tube 20 of a heat exchanger having an adhesive connection 1 according to the present invention lies between 1.5 and 2.5 mm, and that the preferred height h of the annular space 6 filled with adhesive 1 (e.g., the silicone adhesive SK) can be between about 5.0 and about 10.0 mm.

FIG. 4 also reveals that the upper part 60 of the annular space 6 is not filled with the silicone adhesive SK. It has been found that the elasticity and durability of the adhesive connection can be further increased if the degree of filling of the annular spaces 6 with silicone adhesive SK is approximately 60 to 95% of the overall volume of the annular spaces 6.

The silicone adhesive SK that is used is of the addition-crosslinking type, that is to say it does not emit substances while curing. The storage modulus of the silicone adhesive SK in the exemplary embodiment is approximately 1.8 MPa, selected from a range between 0.5 and 3.0 MPa. This relatively low storage modulus value contributes significantly to the long-term durability of the adhesive connection, wherein the adhesive connection has excellent elastic properties, and lasts for a long period of time. In production of the adhesive connection or of the heat exchanger of some exemplary embodiments, the following procedure is followed.

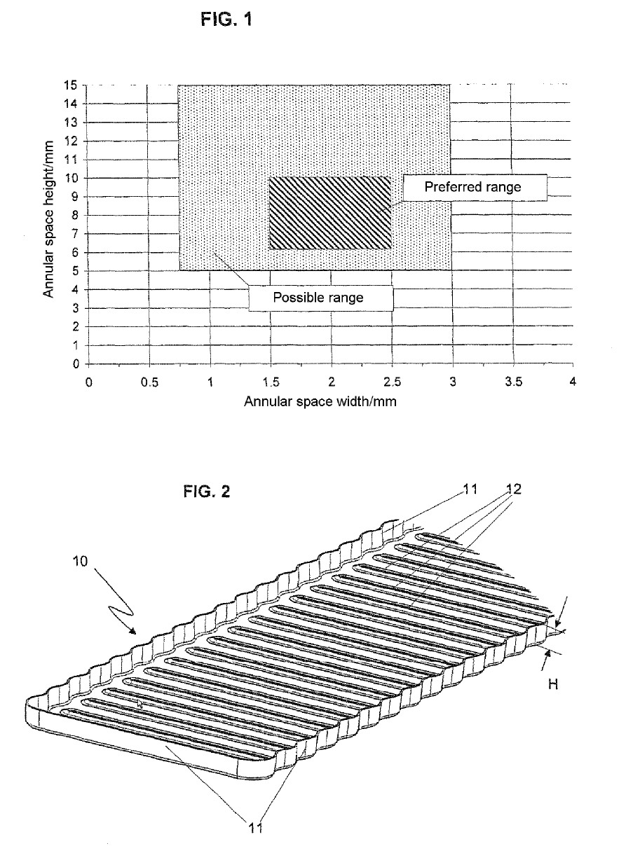

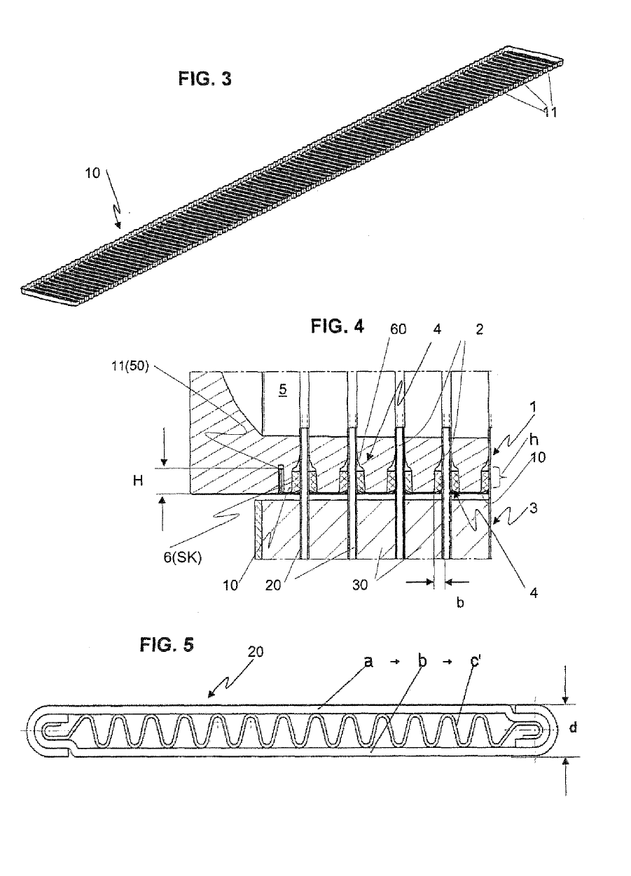

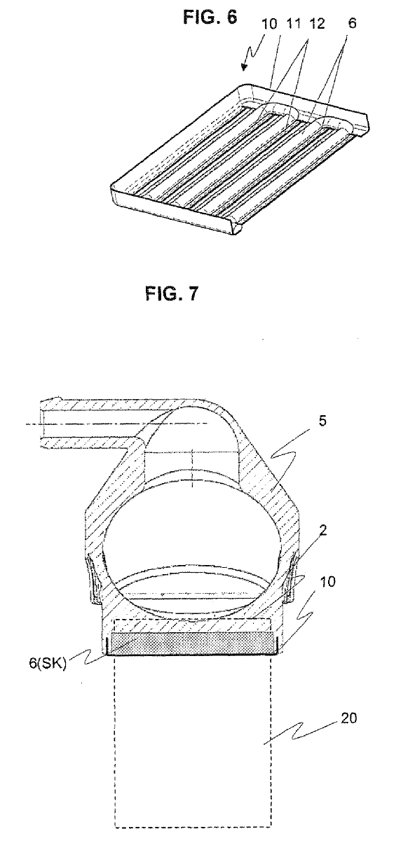

Flat tubes 20, such as that shown in cross-section in FIG. 5, are put together alternately with fins 30 to form a heat exchanger core 3. The heat exchanger core 3 is prepared appropriately for controlled atmosphere brazing, and the brazing process is carried out. The free flat tube ends 2 are freed of any remains of flux or other matter that may interfere with adhesive bonding. Accordingly, in some embodiments, the surfaces of the free flat tube ends 2 are treated. A mounting plate 10 (e.g., see FIGS. 2 and 3) constructed at least in part by a thin foil of approximately 1.0 mm in thickness or less, is pushed with its openings 12 onto the flat tube ends 2, with the edges of the openings 12 lying quite closely against the walls of the flat tubes 20. The mounting plate 10 can finally rest with its underside on the fins 30, without being fastened thereto. In contrast with this, a small distance can be seen in FIG. 4 between the underside of the mounting plate 10 and the fins 30, in accordance with other embodiments of the present invention. Subsequently, a metered amount of silicone adhesive SK is applied in a serpentine line to the inner side of the mounting plate 10, as shown in FIG. 6. After this step, the collecting tank 5 is pushed with its openings 4 onto the free flat tube ends 2. The collecting tank 5 thereby comes together with the shell-like mounting plate 10. In the illustrated embodiment, a wave-like edge 11 of the mounting plate 10 engages in a correspondingly shaped, peripheral groove 50 in the collecting tank 5. The upper side of the mounting plate 10 thereby also becomes adhesively bonded to the underside of the collecting tank 5.

In some embodiments, the collecting tank 5 is formed in one piece. An exemplary embodiment that is not illustrated has a tube sheet made of metal or plastic in which the above-mentioned openings 4 are defined, and which is later connected to a tank part along peripheral edges in order to form the collecting tank 5.

Bringing the shell-like mounting plate 10 together with the collecting tank 5 can have the effect of forcing the silicone adhesive SK into the annular spaces 6. Also, the above-described engagement of the mounting plate edge 11 in the peripheral groove 50 can have the effect of preventing the silicone adhesive SK from escaping laterally when the collecting tank 5 is brought together with the mounting plate 5. Instead, the silicone adhesive is forced to enter the annular spaces 6. The height H (see FIG. 4) of the edge 11 has therefore been designed such that it is engaged into the groove 50 before the silicone adhesive SK is forced into the annular spaces 6. The state shown in FIG. 4 is consequently reached. The degree to which the annular spaces 6 is filled in this exemplary embodiment is approximately 75%, that is to say 25% of the volume of the annular spaces 6 (corresponding to the upper parts of the annular spaces 6 in FIG. 4) is not filled with the silicone adhesive SK. As can also be seen in FIG. 4, the extreme ends of the flat tube ends 2 are inserted in very narrow opening portions, which are parts of the openings 4 in the collecting tank 5, in order to avoid the silicone adhesive SK later coming into significant contact with the medium flowing through the heat exchanger.

It should also be noted with respect to the embodiment of FIG. 4 that, in practice, the flat tube ends 2 do not protrude into the interior of the collecting tank 5, even if FIG. 4 could give a different impression. This is so because when seen in cross section, the collecting tank 5 has in the region of its opening—or in the region of its bottom—an approximately half-round contour in order to improve its compressive stability. Accordingly, FIG. 4 could otherwise give the impression that the flat tube ends 2 project distinctly inward into the opening within the collecting tank 5, which in fact only applies to the portion of the flat tube ends 2 that lie on the center longitudinal line of the collecting tank 5. By employing the tube end-to-collecting tank interior relationship just described, the internal pressure loss has therefore been reduced. The overall cross section of the collecting tank 5 in the illustrated embodiment is of a round to oval form, which FIG. 7 is intended to show. The mounting plate 10, one of the flat tubes 20, and part of an annular space 6 is also shown.

The tensile strength of the silicone adhesive SK in some embodiments is approximately 5.3 MPa, selected from a range of between about 3.0 and 7.0 MPa.

In some embodiments, the viscosity of the silicone adhesive SK is approximately 35,000 cP, selected from a range of between 20,000 and 60,000 cP. With such values, the silicone adhesive SK can be applied without flowing away.

Following the mounting described, a curing process is carried out, and can be performed in a drying oven (not shown) or on a drying line. In some embodiments, the heat exchangers are kept at a temperature of about 120° C. for approximately 30 minutes, selected from a temperature range from 80 to 180° C. and a time period of between 1 and 60 minutes. A catalyst from the group of platinum metals was admixed with the silicone adhesive SK in order to shorten the curing time.

Because the thickness of the tube wall parts a, b (FIG. 5) of the flat tubes 20 can be extremely small (e.g., in a range from 0.03 mm to 0.15 mm in some embodiments), because the fins 30 in some embodiments are only approximately 0.03 mm to 0.09 mm thick, and also because a metal tube sheet is not used in some embodiments, a much lighter heat exchanger is provided. Partly because of the inner inserts c in the flat tubes 20, the characteristic performance values can also lie well above those of conventional heat exchangers. Such heat exchangers can also require much less energy for manufacture, for example during brazing processes. In the preparation of such heat exchangers, the proposed invention makes a significant contribution.

Numerous production tests have shown that, due to various production influences, the exact matching of distances between the flat tube ends to the distances between the edges of openings 12 in the mounting plate 10 is not always ensured. This may result in the flat tube ends 2 and the mounting plate 10 becoming damaged, as a result of which the heat exchanger core and the mounting plate 10 could become unusable. It has been found by means of trials carried out on various embodiments of the edges of the openings 12 and the regions between the openings 12 that making the edges of the openings 12 and/or the distances between the openings 12 able to yield eliminates both the risk of damage caused by unmatched distances and the risk of loss of adhesive escaping through excessive gaps. The yielding compliance of the edges of the openings 12 and/or the distances between the openings 12 in the mounting plate 10 can be represented, for example, by a locally smaller material thickness of the mounting plate 10, and supported by cuts in the edges of the openings 12.

In the production of the adhesive connection or the heat exchanger of some embodiments of the present invention, the following procedure is followed.

Flat tubes 20 are assembled alternately with fins 30 to form the heat exchanger core 3. The heat exchanger core 3 is prepared appropriately for controlled atmosphere brazing, and the brazing process is carried out. The free flat tube ends 2 are removed of any remains of flux or other matter, such as by treating the surfaces of the free flat tube ends 2. A mounting plate 10 made at least in part by a thin foil of approximately 1.0 mm in thickness or less is pushed with its openings 12 onto the flat tube ends 2, whereby the yielding edges 13 of the openings 12 come to lie against the narrow and wide sides of the flat tubes 20.

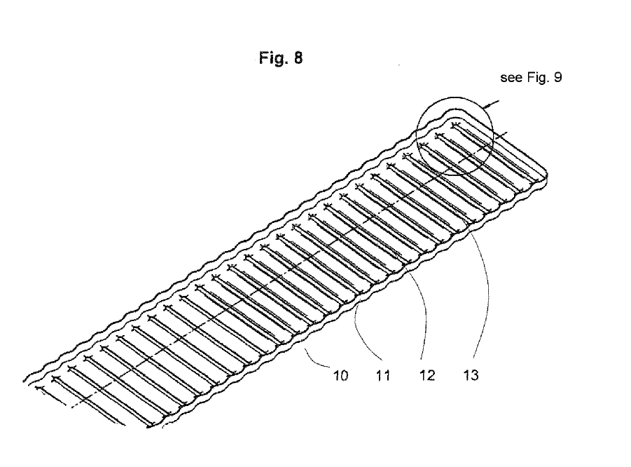

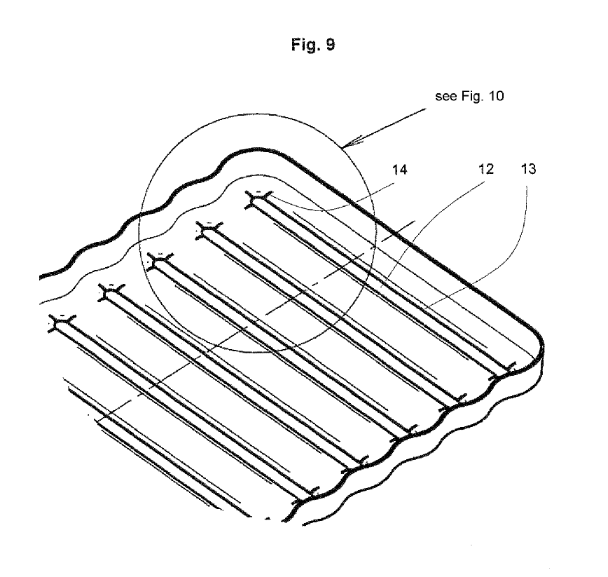

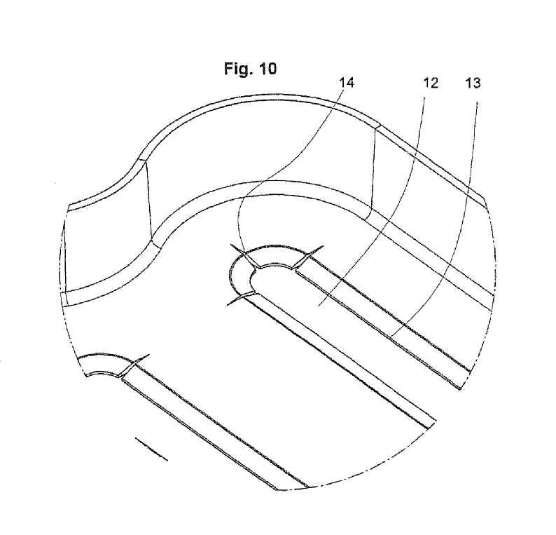

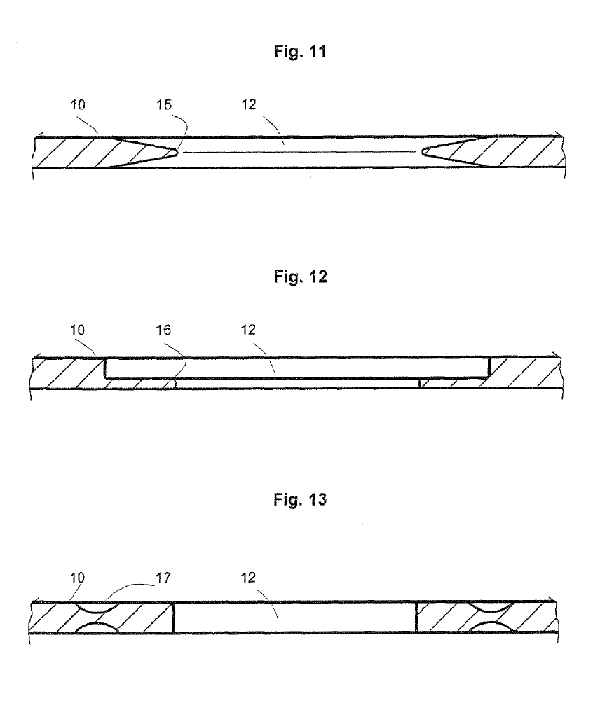

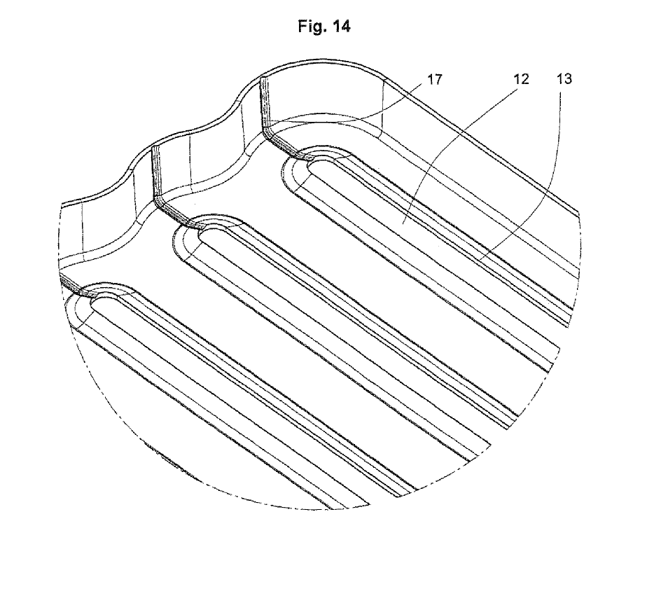

The edges 13 of the openings 12 may be formed with cuts 14 and/or can taper to a point 15, as represented in FIGS. 8-11. A second embodiment of the edges 13 of the openings is shown in FIG. 12, wherein the yielding compliance is provided by a locally reduced material thickness in the form of an offset 16. As a third exemplary embodiment, the locally reduced material thickness is achieved by means of channels 17 or beads, as shown in FIG. 13, wherein the form of the channels or beads are not necessarily restricted to a cross-sectionally arcuate depression as shown.

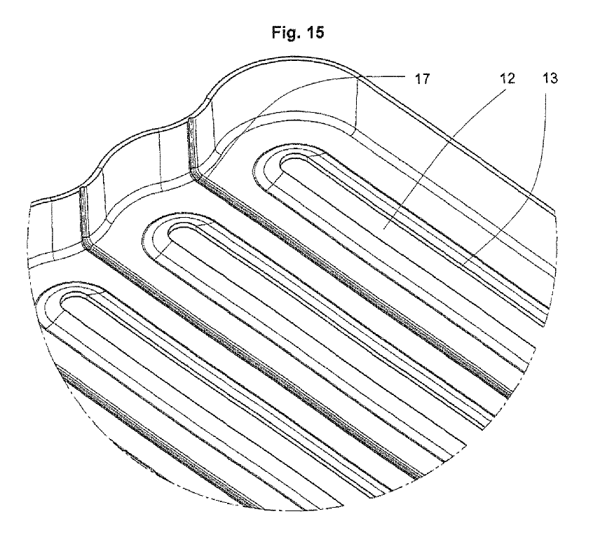

Further exemplary embodiments of the present invention are shown in FIGS. 14 and 15, which illustrate the way in which distances between openings 12 are formed in the mounting plate 10 in a yielding manner by reducing the material thickness in edge regions between openings 12 and the wave-like edges 11 of the mounting plate 10 (FIG. 14), or transversely across the mounting plate 10 between openings 12 (FIG. 15). However, any desired expedient combinations of the mounting plate features described above and illustrated in the accompanying drawings are possible to achieve yielding compliance, or to further increase the same.

The mounting plate 10 can finally rest with its underside on the fins 30, without being fastened thereto. In contrast to this, and as shown by way of example in FIG. 4, a small distance can remain between the underside of the mounting plate 10 and the fins 30. Subsequently, a metered amount of the silicone adhesive SK can be applied in the manner of a serpentine line to the inner side of the mounting plate 10 (not shown). Thereafter, the collecting tank 5 can be pushed with its openings 4 onto the free flat tube ends 2. The collecting tank 5 thereby comes together with the shell-like mounting plate 10. In some embodiments, the wave-like edge 11 of the mounting plate 10 also engages into a correspondingly shaped, peripheral groove 50 in the collecting tank 5. The upper side of the mounting plate 10 thereby also becomes adhesively bonded to the underside of the collecting tank 5.

Bringing the shell-like mounting plate 10 together with the collecting tank 5 can have the effect of forcing silicone adhesive SK into the annular spaces 6. The above-described engagement of the edge 11 of the mounting plate 10 into the peripheral groove 50 can also have the effect of preventing silicone adhesive SK from escaping laterally when the collecting tank 5 is brought together with the mounting plate 10. Instead, the silicone adhesive SK is forced to enter the annular spaces 6.

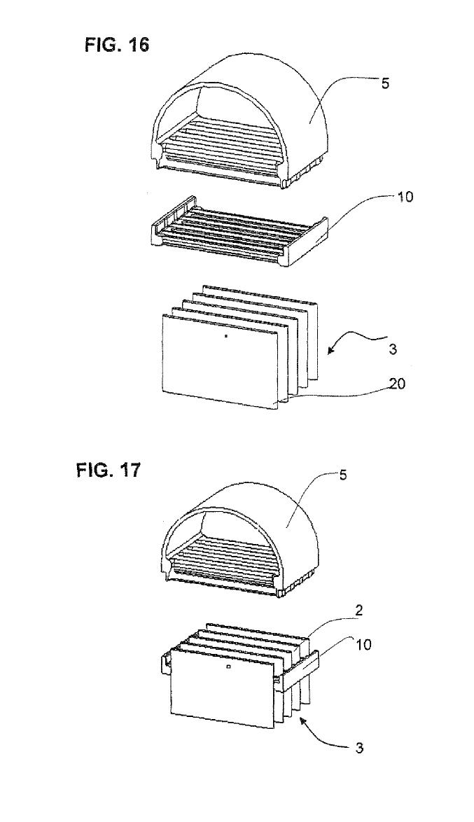

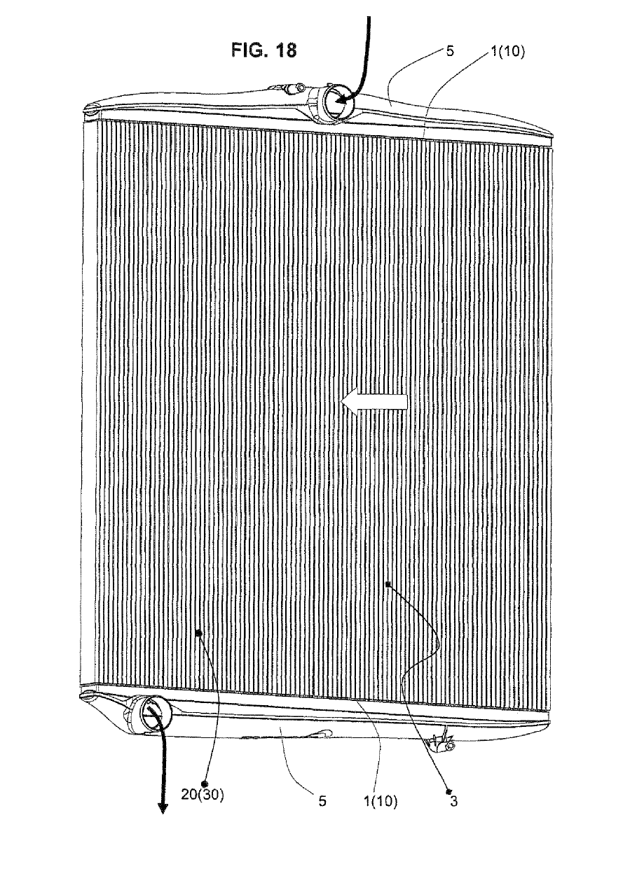

FIG. 18 shows a cooling liquid cooler (heat exchanger) of a truck, wherein cooling air flows through the core of the cooler. This cooling liquid cooler has the proposed adhesive connection of the present invention at the flat tube ends 2, and can be produced according to the methods described herein. FIGS. 16 and 17 show the production sequence of the cooling liquid cooler, starting from an already-brazed heat exchanger core 3 consisting of flat tubes 20 and fins 30 (not shown). First, the mounting plate 10 is pushed onto the flat tube ends 2. Silicone adhesive SK of the addition-crosslinking type is applied, and the flat tube ends 2 are pushed into the openings 4 in the collecting tank 5, with the mounting plate 10 being brought together with the collecting tank 5 and the silicone adhesive being forced into the annular spaces 6.

The embodiments described above and illustrated in the accompanying figures are presented by way of example only, and are not intended as a limitation upon the concepts and principles of the present invention. As such, it will be appreciated by one having ordinary skill in the art that various changes in the elements and their configuration and arrangement are possible without departing from the spirit and scope of the present invention.

What is claimed is:

1. An adhesive connection for a heat exchanger having a brazed core comprising flat metal tubes with flat metal tubes ends received in corresponding openings defined in a collecting tank, the adhesive connection comprising:
an annular space around each of the flat tube ends and defined at least in part by the collecting tank;
an addition-crosslinking silicone adhesive located within the annular space; and
a mounting plate at least partially closing each annular space.

2. The adhesive connection as claimed in claim 1, wherein the annular spaces are each filled to approximately 60-95% of their volume with the silicone adhesive.

3. The adhesive connection as claimed in claim 1, wherein:
each annular space has a height extending in a longitudinal direction of the tubes, and a width,
approximately 5-15 mm of the height of the annular spaces is filled with the silicone adhesive, and
the width of the annular spaces is approximately 0.5 to 3.0 mm.

4. The adhesive connection as claimed in claim 1, wherein the silicone adhesive is prepared from at least two components.

5. The adhesive connection as claimed in claim 1, wherein the elongation of the silicone adhesive is greater than 100%.

6. The adhesive connection as claimed in claim 1, wherein the silicone adhesive has a storage modulus in the range of between approximately 0.1 and 3.0 MPa.

7. The adhesive connection as claimed in claim 1, wherein the tensile strength of the silicone adhesive is approximately between 3.0 and 7.0 MPa.

8. The adhesive connection as claimed in claim 1, wherein the silicone adhesive has a catalyst selected from the group of platinum metals and their compounds.

9. The adhesive connection as claimed in claim 1, wherein the silicone adhesive has a dynamic viscosity of approximately 20,000 to 60,000 cP.

10. The adhesive connection as claimed in claim 1, wherein each annular space has approximately the same width over the height that is filled with the silicone adhesive.

11. The adhesive connection as claimed in claim 1, wherein each annular space has a changing width across the height of the annular space that is filled with the silicone adhesive.

12. The adhesive connection as claimed in claim 1, wherein that part of each annular spaces that is not filled with the silicone adhesive is positioned facing the collecting tank.

13. The adhesive connection as claimed in claim 1, wherein the mounting plate is formed as a thin foil with an upright, peripheral edge having a height.

14. The adhesive connection as claimed in claim 1, wherein:
an edge of the mounting plate engages into a corresponding groove of the collecting tank; and
the mounting plate either lies with an underside of the mounting plate on fins of the brazed heat exchanger core or is a distance from the fins.

15. The adhesive connection as claimed in claim 1, wherein the collecting tank has one of a round or oval shape in cross section.

16. The adhesive connection as claimed in claim 1, further comprising openings defined in the mounting plate, wherein at least one of edges of the openings in the mounting plate and distances between the openings of the mounting plate are formed in a yielding manner.

17. The adhesive connection as claimed in claim 16, wherein yielding compliance of the edges of the openings in the mounting plate are provided by a local reduction in material thickness of the mounting plate.

18. The adhesive connection as claimed in claim 16, wherein the yielding compliance of the edges of the openings in the mounting plate are provided by cuts in the edges of the openings in the mounting plate.

19. The adhesive connection as claimed in claim 17, wherein the local reduction in material thickness of the mounting plate is represented by a cross section of the mounting plate at the openings thereof tapering to a point.

20. The adhesive connection as claimed in claim 17, wherein the local reduction in material thickness of the mounting plate is represented by a cross section with an offset.

21. The adhesive connection as claimed in claim 17, wherein the local reduction in material thickness of the mounting plate is represented by a cross section with at least two channels therein.

22. The adhesive connection as claimed in claim 16, wherein yielding compliance of the distances between the openings in the mounting plate is provided by a reduction in material thickness between the openings in the mounting plate.

23. The adhesive connection as claimed in claim 16, wherein yielding compliance of the distances between the openings in the mounting plate is provided by a reduction in material thickness in regions between the openings in the mounting plate, and by wave-like edges of the mounting plate.

24. A method for producing an adhesive connection for flat metal tube ends in corresponding openings of a collecting tank of a heat exchanger, the method comprising:
pushing an addition-crosslinking type silicone adhesive into annular spaces located between each flat tube end and a corresponding opening of the collecting tank with a mounting plate;
at least partially filling the annular spaces by pushing the silicone adhesive into the annular spaces with the mounting plate; and
closing the annular spaces with the mounting plate.

25. The method as claimed in claim 24, wherein the annular spaces are filled to approximately 60 to 95% of their volume with the silicone adhesive.

26. The method as claimed in claim 24, further comprising:
applying a metered amount of silicone adhesive to the mounting plate prior to pushing the silicone adhesive into the annular spaces; and
forcing the metered amount of silicone adhesive into the annular spaces by bringing together the mounting plate and the collecting tank.

27. The method as claimed in claim 24, wherein the mounting plate has an upright edge, the method further comprising:
inserting the edge of the mounting plate into a corresponding slot defined in the collecting tank; and
pushing the silicone adhesive after inserting the edge of the mounting plate.

28. The method as claimed in claim 24, further comprising admixing a catalyst with the silicone adhesive.

29. The method as claimed in claim 24, further comprising cleaning the flat tube ends to ensure direct metal contact of the silicone adhesive.

30. The method as claimed in claim 24, wherein the silicone adhesive is a type comprising one component, or is mixed in advance from at least two components.

31. The method as claimed in claim 24, further comprising exposing at least one of the silicone adhesive and the heat exchanger to a temperature of approximately 80 to 180° C. over a time period of 1 to 60 minutes to allow the silicone adhesive to cure.

32. A method for producing a heat exchanger, the method comprising:
brazing a heat exchanger core of alternating fins and flat tubes in a brazing furnace;
applying an addition-crosslinking type silicone adhesive onto at least one of a mounting plate having a plurality of openings and a collecting tank having a plurality of openings;
inserting ends of the flat tubes into the openings of the mounting plate and into the openings of the collecting tank;
bringing the mounting plate together with the collecting tank; and
forcing the silicone adhesive into annular spaces between the collecting tank and each of the flat tube ends by bringing the mounting plate and the collecting tank together.
